(19) United States
(12) Patent Application Publication
(10) Pub. No.: US 2006/0043924 A1
(43) Pub. Date: Mar. 2, 2006

(54) Arrangement for charging at least two batteries

(76) Inventors: Jurgen Rautmann, Henstedt-Ulzburg (DE); Kia von Berg, Hamburg (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/211,335

(22) Filed: Aug. 25, 2005

(30) Foreign Application Priority Data
Aug. 28, 2004 (DE) 10 2004 041 722.9

(51) Int. Cl. H02J 7/00

(52) U.S. Cl. 320/103

(57) ABSTRACT

Arrangement for charging at least two traction batteries for an industrial truck comprising a charging unit adapted to be connected to a traction batteries through charging cable, change-over means having an input connected to the charging unit and at least two outputs which through charging cables each may be connected to charging batteries, detection means which generate a change-over signal if one traction battery is completely charged, the change-over means switch the input to the other output if the change-over means receives a change-over signal from the detection means.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The traction batteries of battery-driven industrial trucks constantly have to be recharged after use. This takes place by means of a charging unit which generally is connected to the mains power supply in a charging station and to which the batteries of the industrial trucks are transported. Alternatively, it is naturally also possible to take industrial trucks with a built-in battery to a charging station. Additionally, it has also become known to integrate charging units in an industrial truck. The present invention, however, is concerned with charging batteries where the charging unit is separate from the industrial truck.

Industrial trucks are generally not in use around the clock but, for example, only for one shift. If the period of use is eight hours, sixteen hours of charging time are available. Based on the fact that a charging time of eight hours is sufficient, two batteries may be charged one after the other by one charging unit. So that such a charging process may be carried out, corresponding operating personnel are required who, after recharging the first battery, disconnect said first battery from the charging unit and connect the next battery to the charging unit. The cost thereof is relatively high, especially as the described transfer generally has to be carried out during the night.

Current charging units are designed so that they automatically finish charging as soon as it is established that the battery is recharged. The fully charged state may be determined in different ways, by measuring, for example, the power and/or voltage and/or the amount of energy. If this state is reached, the charging unit is automatically electrically disconnected from the battery. It is also known to associate a detection device with a battery which detects the fully charged state which is transmitted either wirelessly or via a signal line to the charging unit and causes it to be switched off. It is further known to design the charging unit so that a battery is automatically recharged when, by means of appropriate measurements, the charging unit registers that a battery to be charged is connected.

A charging station for electric-powered vehicles has become known from DE 200 13 399 U1, in which a power supplying circuit comprises a plurality of charging sockets, each of which being able to be connected to an electric-powered vehicle. The connection is made via relays, the different relays being automatically controlled according to a specific schedule, so that an economical design results and overcharging is avoided.

A charging station for batteries has become known from EP 0 314 155 B1, in which a plurality of batteries are sequentially charged, for example the batteries having to be recharged the least, being charged first. The charging schedule, in turn, is geared to the efficiency of the charging, said charging being determined by the measurement of different parameters, for example being dependent on the respective charge state of the batteries.

It has become known from EP 1 332 539 to charge the individual cells of a battery sequentially, a control device controlling the change-over from one cell to the next according to whether a defined charging characteristic is reached.

The object of the invention is to provide an arrangement for charging at least two traction batteries with which a charging unit may automatically charge the greatest possible number of batteries within a predetermined period and at low cost.

### BRIEF SUMMARY OF TH INVENTION

According to the invention, an input of a change-over device is connected to the output of the charging unit, which change-over device comprises at least two outputs which may be connected to the at least two batteries via one respective charging cable. The input of the change-over device is respectively connected to only one output, it being ensured by a suitable control that the input may be optionally connected to a predetermined output. The input of the change-over device is switched to another output when the change-over device receives the signal of the detection means as a change-over signal.

It could be taken as an example that a user operates two industrial trucks which are in operation during a shift, for example from 08.00 to 14.00 hours. During operation, the batteries of the vehicles are more or less discharged. By means of the invention, firstly the battery of the first vehicle is charged from, for example, 14.00 to 22.00 hours. Subsequently, a change-over takes place to the battery of the other vehicle which is charged from, for example, 22.00 to 06.00 hours in the morning. This charging process is carried out automatically with the arrangement according to the invention, a change-over of the connection of the charging unit from one battery to the other then taking place when the detection means establishes that the first-charged battery is substantially fully recharged or continuing to be recharged. Consequently, a corresponding change-over signal is generated for the change-over device so that the two batteries are automatically recharged.

With the arrangement according to the invention, the change-over device may, according to an embodiment of the invention, be integrated in the charging unit, or externally attached to the housing of the charging unit. Preferably, the change-over device which comprises a suitable switch, is arranged in the vicinity of the output, which is usually provided, of a charging unit, so that the switch may be directly connected to the output of the battery. The switch comprises a suitable actuator. According to the invention, the detection device which is normally present in a charging unit may generate a change-over signal. Normally the detection device would generate a switch-off signal for the state approaching full charge. If the charging unit is designed so that recharging begins automatically when a discharged battery is connected, the charging unit is easily changed over to another battery by means of the invention, as even a switched-off charging unit switches on again when a discharged battery is connected. If the charging does not start automatically, the charging unit has to be prevented from switching off when a battery reaches full charge. If a change-over were to be carried out in this state, the second battery would no longer be automatically charged as the charging unit would be switched off. In this case it would be advantageous if the change-over of the change-over device occurred when the first battery was not yet completely recharged and therefore the charging unit had not yet been automatically switched off.

It is also possible in a further embodiment of the invention to generate the change-over signal in the change-over device itself, said change-over device being provided with a detection means which may detect the charge state of the respective battery.

The change-over device according to the invention may also be provided separately from the charging unit and, for example, be accommodated in a separate housing. It is connected by means of a cable or the like to the charging unit. It is possible to have two or more parallel outgoing charging cables from the change-over unit which are connected to batteries to be charged. It may be expedient in this case if the change-over unit is provided with separate detection means relative to the charge state of the respective battery. It is, however, also conceivable to use the detection means of the charging unit, which is normally integrated in each charging unit, to generate the change-over signal. In this case, however, it is necessary to provide an additional line between the charging unit and the change-over device, via which either a change-over signal is then transmitted which activates an actuation device for the switch in the change-over device or an actuation signal for the actuation device of the switch being directly transmitted from the charging unit to the change-over device. In the letter case the energy of the signal is sufficient, to actuate the change-over device.

If the charge state is detected directly on the battery, it is also possible to provide a wireless or wire-bound communication between the battery and the change-over device in order to generate a change-over signal automatically.

The detection means in the charging unit and/or in the change-over device for detecting the charge state of a battery may detect different parameters, for example the charging current and/or the charging voltage and/or the energy supplied into the battery. It is, however, also possible to work time-dependently, for example, the charging period being set by means of a timer. In this case, after a first charging period, a change-over signal could be generated from the timer for the change-over device, so that the next battery is automatically charged in a second charging period.

### BRIEF DESCRIPTION OF THE SEVERAL VIEWS OF THE DRAWINGS

Two embodiments of the invention will be described hereinafter with reference to the drawings, in which:

FIG. 1 is a diagrammatic view of a first embodiment of the arrangement according to the invention.

FIG. 2 is a diagrammatic view of a second embodiment of the arrangement according to the invention.

FIG. 3 is a diagrammatic view on a change-over device for the arrangement according to the invention.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

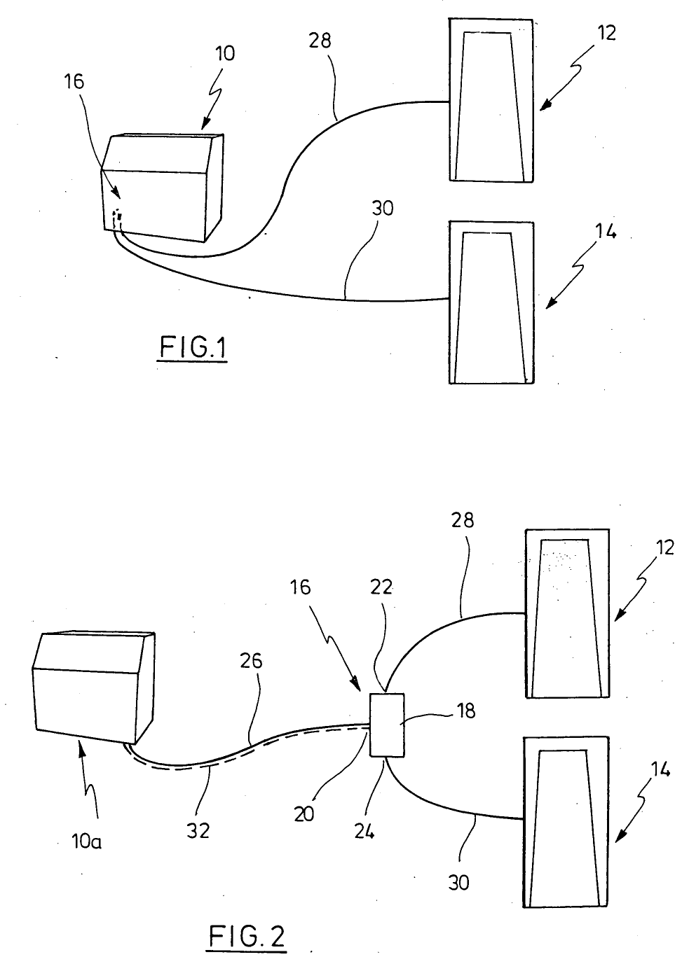

In FIGS. 1 and 2 one respective charging unit 10 and 10a can be seen, by which two batteries 12, 14 are recharged. Reference is firstly made to FIG. 2.

In FIG. 2 a change-over device at 16 is accommodated in a housing 18. Individual parts of the change-over device are not shown but are to be at least shown in outline. The change-over device 16 comprises an input 20 and two outputs 22, 24. The input 20 may be connected to a charging unit 10a with a cable 26 via a plug connection. The connection of the cable 26 to the charging unit 10a may also be made via a plug connection or in another manner. Cables 28, 30 are respectively connected to the outputs 22, 24, again for example via plug connections. The cables 28, 30 are so-called charging cables which may be connected in an appropriate manner to the batteries 12, 14. The batteries are, for example, traction batteries from industrial trucks.

The change-over device 16 contains a switch, for example a contractor, a relay or a semi-conductor switch which is such that it connects the input 20 to only one of the respective outputs 22 or 24. Furthermore, a switch actuator is therefore provided in the change-over device 16, which optionally positions the switch so that the input 20 is connected to the desired output 22, 24.

The change-over device 16 further contains a detection means, with which the charge state of the respectively charged battery 12, 14 may be detected, for example via power and/or voltage during charging or even by detecting the capacity still present before the start of the charging and during the charging process. Such detection means are known per se. In the present case the detection means generate a change-over signal for the actuation device of the switch when it is established that the fully charged state is reached.

It may be assumed that at the start of a charging process the charging unit 10a charges the battery 12 via a corresponding switch position in the change-over device 16. The start of the charging process is initiated automatically, as soon as the more or less empty battery 12 is connected to the charging unit 10a. The charging unit 10a is indeed able to determine whether the connected battery requires recharging. If this is the case, the charging process begins. If, by using the detection means in the change-over device 16, it is determined that the battery 12 is full, the detection means generates an inverted signal and the switch in the change-over device 16 connects the input 20 to the output 24, so that the battery 14 is automatically charged until said battery also reaches its fully charged state. Intervention by an operator is not required for charging the two batteries 12, 14.

If the change-over device 16 does not comprise means for detecting the charge state of the batteries 12, 14, the corresponding means may also be adopted in the charging unit 10a. Charging units generally have such detection means and automatically switch off when the fully charged state is reached. So that, in this case, the change-over device 16 may change over to the battery 14, it is necessary to actuate the switch in the change-over device 16 via the charging unit 10a. To this end, an additional line, which is indicated at 32 by dotted lines, may be provided in order to transmit a control signal or a command signal for the change-over device 16 via this line 32. A wireless transmission may also be carried out instead of a line 32.

The embodiment according to FIG. 1 differs from that of FIG. 2 in that the change-over device 16 is integrated in the housing of the charging unit 10. The internal construction may however be similar to the device 16 according to FIG. 2, with a switch also being provided which optionally connects the change-over device 16 and thus the charging unit 10 to one of the charging cables 28, 30. The input of the change-over device 16 is directly connected to the output of the charging unit, the detection means already present being used in the charging unit 10 for change-over purposes, in order to carry out a change-over in the change-over device 16 when a battery reaches the fully charged state. It is understood that the change-over device 16 according to FIG. 1 also has a separate ability to detect the charge state of the batteries in order to effect the described automatic change-over from one battery to the other.

In the embodiment according to FIG. 1 modifications are necessary to the charging unit in order to equip it according to the invention. In the embodiment according to FIG. 2 an alteration is not required to the charging unit. The cost of the change-over device 16 is relatively small. In any case, it is clearly less than using a second charging unit.

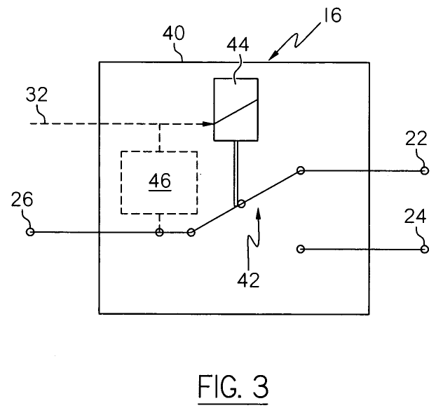

FIG. 3 shows the change-over device 16 having a housing 40. The housing includes a change-over switch 42 having a switch contact connected to the input 20. The contact points of the change-over switch 42 are connected to the outputs 22 and 24.

An electromagnet 44 actuates the switch contact. The detection device 46 is also within housing 40 which is to detect the state of the traction battery. In case the battery is fully charged it actuates the magnet 44 in order to actuate the change-over switch 42. Alternatively, the state of the traction battery may be detected by a detection device 46a in the housing of the charging device 10a (FIG. 2). In this case a signal is transmitted over line 32 in order to actuate electromagnet 44.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. Arrangement for charging at least two traction batteries for an industrial truck comprising a charging unit adapted to be connected to a traction batteries through charging cable, change-over means having an input connected to the charging unit and at least two outputs which through charging cables each may be connected to charging batteries, detection means which generate a change-over signal if one traction battery is completely charged, the change-over means switch the input to the other output if the change-over means receives a change-over signal from the detection means.

2. Arrangement according to claim 1, characterized in that the change-over device (16) is integrated in the charging unit (10) and/or attached to the housing of the charging unit (10).

3. Arrangement according to claim 2, characterized in that the change-over signal is generated by a detection means of the charging unit (10).

4. Arrangement of claim 1, characterized in that the detection means are located in the change-over means.

5. Arrangement according to claim 1, characterized in that the detection means contains a timer.

6. Arrangement according to claim 1, characterized in that the detection means measures the power and/or the voltage and/or the capacity of the battery.

7. Arrangement according to claim 1, characterized in that the change-over device comprises a contractor, a relay, a semi-conductor switch or the like.

8. Arrangement according to claim 1, characterized in that the change-over device (16) is arranged in a separate housing (18) and may be connected to the charging unit (10a) via a cable (26).

9. Arrangement according to claim 8, characterized in that the detection means is arranged in the housing (18) of the change-over device (16).

10. Arrangement according to claim 8, characterized in that between the charging unit (10a) and the change-over device (16) a wireless or wire-bound control path (32) is arranged for transmitting a control signal from the charging unit (10a) for changing over the change-over device (16) or a change-over signal of the detection means in the charging unit (10a).

11. Arrangement according to claim 8, characterized in that between the charging unit (10a) and the change-over device a wireless or wire-bound transmission path is arranged for transmitting the change-over signal from the detection means of the charging-unit (10a), a change-over means generating a control command for the change-over device according to the change-over signal.

12. Arrangement of claim 1, characterized in that starting means are provided which start the charging by the charging unit if the detection means detect that a traction battery is partially discharged.

13. The arrangement of claim 1, characterized in that a change-over signal is generated shortly before the detection means detects that the traction battery is completely charged.
